(19) United States
(12) Patent Application Publication
(10) Pub. No.: US 2012/0321960 A1
(43) Pub. Date: Dec. 20, 2012

(54) NEGATIVE ACTIVE MATERIAL FOR RECHARGEABLE LITHIUM BATTERY, METHOD OF PREPARING THE SAME, AND NEGATIVE ELECTRODE AND RECHARGEABLE LITHIUM BATTERY INCLUDING THE SAME

(75) Inventors: Hee-Joong KIM, Yongin-si (KR); Sumihito Ishida, Yongin-si (KR); Eui-Hwan Song, Yongin-si (KR)

(73) Assignee: SAMSUNG SDI CO., LTD., Yongin-si (KR)

(21) Appl. No.: 13/328,939

(22) Filed: Dec. 16, 2011

Related U.S. Application Data
(60) Provisional application No. 61/499,086, filed on Jun. 20, 2011.

(51) Int. Cl. H01M 4/583; C01B 31/00

(52) U.S. Cl. 429/231.8; 423/445 R

(57) ABSTRACT

Provided are A carbon-based material having a FWHM ranging from 2.5° to 6.0° at 2θ ranging from 20° to 30° in a XRD pattern using CuKα ray and a peak area ratio ranging from 1.0 to 100.0 between FWHM at 2θ ranging from 20° to 30° and FWHM at 2θ ranging from 50° to 53°, and a method of manufacturing the carbon-based material, and a negative electrode and a rechargeable lithium battery including the same.

### CROSS-REFERENCE TO RELATED APPLICATIONS

This application claims priority under 35 U.S.C. §119(e) to U.S. Provisional Application No. 61/499,086 filed Jun. 20, 2011, which is hereby incorporated by reference in its entirety.

### BACKGROUND

1. Field

This disclosure relates to a negative active material for a rechargeable lithium battery, a method of preparing the same, and a negative electrode and a rechargeable lithium battery including the same.

2. Description of the Related Technology

Lithium rechargeable batteries have recently drawn attention as a power source of small portable electronic devices. They use an organic electrolyte solution and thereby have roughly twice the discharge voltage of a conventional battery using an alkali aqueous solution, and accordingly have high energy density.

Such rechargeable lithium batteries are used by injecting an electrolyte into a battery cell including a positive electrode including a positive active material that can intercalate and deintercalate lithium and a negative electrode including a negative active material that can intercalate and deintercalate lithium.

Research is underway on a next generation battery having both of advantages of the rechargeable lithium battery and advantages of a super capacitor, that is, a battery having high energy density, excellent cycle-life and stability characteristics, and the like.

### SUMMARY

One embodiment provides a negative active material for a rechargeable lithium battery having high-capacity, and excellent high rate capabilities and cycle-life at a high rate.

Another embodiment provides a method of preparing the negative active material for a rechargeable lithium battery.

Yet another embodiment provides a negative electrode for a rechargeable lithium battery including the negative active material.

Still another embodiment provides a rechargeable lithium battery including the negative active material.

According to one embodiment, provided is a negative active material for a rechargeable lithium battery, which includes a carbon-based material. The carbon-based material has a full width at half maximum (FWHM) ranging from 2.5° to 6.0° at 2θ ranging from 20° to 30° in the XRD pattern using CuKα ray and a peak area ratio ranging from 1.0 to 100.0 of FWHM at 2θ ranging from 50° to 53° relative to FWHM at 2θ ranging from 20° to 30°.

In some embodiments the carbon-based material has an R_{AB} value of from about 2.0 to about 4.0, wherein (R_{AB}) is the ratio of the height of a peak (B) to the height of the background (A) in an XRD pattern.

In some embodiments the carbon-based material comprises carbon with an interplanar spacing d(002) of from 3.370 to 3.434 Å.

The carbon-based material may include low crystalline soft carbon.

The carbon-based material may have FWHM ranging from 3.5° to 5.5° at 2θ ranging from 20° to 30° in a XRD pattern using CuKα ray.

The carbon-based material may have a peak area ratio ranging from 1.0 to 50.0 of FWHM at 2θ ranging from 50° to 53° relative to FWHM at 2θ ranging from 20° to 30° in the XRD pattern using CuKα ray.

The carbon-based material may have a peak area ratio ranging from 1.0 to 100.0 of FWHM at 2θ ranging from 42° to 45° relative to FWHM at 2θ ranging from 20° to 30° in the XRD pattern using CuKα ray.

The carbon-based material may have a peak area ratio ranging from 0.1 to 50.0 of FWHM at 2θ ranging from 50° to 53° relative to FWHM at 2θ ranging from 42° to 45° in the XRD pattern using CuKα ray.

The carbon-based material may have an average particle diameter (D50) ranging from 5 to 20 μm.

In the carbon-based material, carbon has interplanar spacing d(002) ranging from 3.00 to 5.00 Å or 3.370 to 3.434 Å and a lattice constant of Lₐ ranging from 1000 to 3000 Å and L_{c} ranging from 10 to 35 Å.

The carbon-based material may have a specific surface area ranging from 2.5 to 20 m²/g.

The carbon-based material may have tap density ranging from 0.30 to 1.00 g/cm³ and true density ranging from 1.00 to 3.00 g/cm³.

According to one embodiment, provided is a method of manufacturing a negative active material for a rechargeable lithium battery, which includes firing a carbon-based material at a temperature ranging from 900 to 1500° C. In some embodiments, the firing temperature of the carbon-based material can be from 900 to 1200° C.

The carbon-based material may include soft carbon.

According to yet another embodiment, a negative electrode for a rechargeable lithium battery including the negative active material is provided.

The negative electrode may have an active mass level ranging from 2.0 to 10.0 mg/cm².

The negative electrode may have a thickness ranging from 45 to 100 μm.

The negative electrode may have electrical conductivity ranging from 1.00 to 4.00 s/m.

The negative electrode may have binding properties ranging from 0.50 to 6.00 gf/mm.

According to still another embodiment, a rechargeable lithium battery that includes a negative electrode including negative active material; a positive electrode; and an electrolyte is provided.

The rechargeable lithium battery may have reversible capacity ranging from 250 to 400 mAh/g.

The detailed specifications of other embodiments are included in the following detailed description.

Therefore, the present embodiments may provide a rechargeable lithium battery having high-capacity and excellent high rate capabilities and cycle-life at a high rate and in particular, a lithium ion battery for a hybrid vehicle having high input and output.

### BRIEF DESCRIPTION OF THE DRAWINGS

FIG. 1 is a schematic view of a rechargeable lithium battery according to one embodiment.

FIG. 2A and 2b schematically shows the SEM (scanning electron microscope) photograph of each negative active material according to Example 1 and Comparative Example 2.

FIG. 3 provides a graph showing the XRD (X-ray diffraction) pattern of the negative active materials according to Example 1 and Comparative Examples 1 and 2.

FIG. 4 provides the EDS (Energy Dispersive Spectrometry) analysis graph of the negative active material according to Example 1.

FIG. 5 provides a graph showing cycle-life characteristic of rechargeable lithium batteries of Example 1 and Comparative Example 2 at a high rate.

### DETAILED DESCRIPTION OF CERTAIN INVENTIVE EMBODIMENTS

Example embodiments of this disclosure will hereinafter be described in detail. However, these embodiments are only examples, and this disclosure is not limited thereto.

The negative active material for a rechargeable lithium battery according to one embodiment includes a carbon-based material.

The carbon-based material may have full width at half maximum (FWHM) ranging from 2.5° to 6.0° at 2θ ranging from 20° to 30° in the XRD pattern using CuKα ray and in some embodiments ranging from 3.5° to 5.5°. In addition, the carbon-based material may have a peak area ratio ranging from 1.0 to 100.0 of FWHM at 2θ ranging from 50° to 53° relative to FWHM at 2θ ranging from 20° to 30° and in some embodiments, ranging from 1.0 to 50.0. The carbon-based material with FWHM and a peak area ratio within the range has low crystalline. When the low crystalline carbon-based material is used as a negative active material, it may secure high-capacity, high rate capabilities and cycle-life at a high rate by factors of a pore due to imperfect structure of a layer, a cross-section line, and a layer gap due to a molecular bridging reaction among molecule clusters.

The FWHM (full width at half maximum) indicates a full width at 50% between the lowest and highest points of the intensity of a peak.

The area of the peak may be calculated through integration. Some embodiments relate to the ratio (R_{AB}) of the height of a peak (B) to the height of the background (A) in an XRD pattern. In some embodiments, the carbon-based material has an R_{AB} value of from about 2.0 to about 4.0.

In addition, the carbon-based material may have a peak area ratio ranging from 1.0 to 100.0 of FWHM at 2θ ranging from 42° to 45° relative to FWHM at 2θ ranging from 20° to 30° in the XRD pattern using CuKα ray. Furthermore, the carbon-based material may have a peak area ratio ranging from 0.1 to 50.0 of FWHM at 2θ ranging from 50° to 53° relative to FWHM at 2θ ranging from 42° to 45° and in some embodiments, from 0.1 to 20.0 in the XRD pattern using CuKα ray. The carbon-based material having a peak area ratio within the range has a low crystalline. When the low crystalline carbon-based material is used as a negative active material, a rechargeable lithium battery may have high rate capabilities and excellent cycle-life characteristic at a high rate.

The carbon-based material may be in particular low crystalline soft carbon with FWHM and a peak area ratio within the range. Soft carbon is a carbon material that is susceptible to a layered-structure by a heat treatment due to the aggregation of graphite particles in an orderly manner.

The carbon-based material may have an average particle diameter (D50) ranging from 5 to 20 μm and in some embodiments, from 5 to 15 μm. When the carbon-based material with an average particle diameter (D50) within the range is used as a negative active material, the low crystalline carbon-based material may accomplish excellent high rate capabilities and cycle-life characteristic of a battery at a high rate.

In the carbon-based material, carbon has an interplanar spacing d(002) ranging from about 3.00 to about 5.00 Å for example, from 3.370 to 3.434 Å. Furthermore, the carbon-based material may have a lattice constant of Lₐ ranging from about 1000 to about 3000 Å and L_{c} ranging from about 10 to about 35 Å and in some embodiments, of Lₐ ranging from about 1000 to about 2000 Å and L_{c} ranging from about 20 to about 35 Å. When a carbon-based material with an interplanar spacing d(002) and a lattice constant within the range is used as a negative active material, the carbon-based material may be low crystalline and accomplish excellent high rate capabilities and cycle-life characteristics at a high rate.

The carbon-based material may have a specific surface area ranging from 2.5 to 20 m²/g and in some embodiments, from 1 to 10 m²/g. When a carbon-based material with a specific surface area within the range is used as a negative active material, the carbon-based material may be low crystalline and may bring about excellent high rate capabilities and cycle-life characteristic at a high rate.

The carbon-based material may have tap density ranging from 0.30 to 1.00 g/cm³ and in some embodiments, from 0.60 to 1.30 g/cm³. In addition, the carbon-based material may have true density ranging from 1.00 to 3.00 g/cm³ and in some embodiments, from 1.50 to 2.50 g/cm³. When a carbon-based material with tap density and true density within the range, the carbon-based material may be low crystalline and accomplish excellent high rate capabilities cycle-life characteristic at a high rate.

The low crystalline carbon-based material may be prepared by firing a carbon-based material at a temperature ranging from 900 to 1500° C. In some embodiments, the firing temperature of the carbon-based material can be from 900 to 1200° C.

The carbon-based material may be soft carbon.

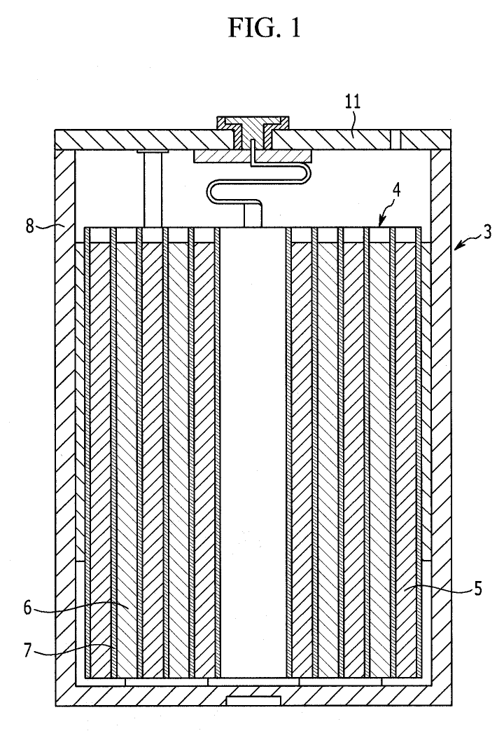

Hereinafter, a rechargeable lithium battery including the negative active material is described referring to FIG. 1.

FIG. 1 is a schematic view of a rechargeable lithium battery according to one embodiment.

Referring to FIG. 1, a rechargeable lithium battery 3 according to one embodiment is a prismatic battery that includes an electrode assembly 4 including a positive electrode 5, a negative electrode 6, and a separator 7 interposed between the positive electrode and negative electrode 6 in a battery case 8, and electrolyte injected through an upper portion of the battery case 8, and a cap plate 11 sealing the case. However, a rechargeable lithium battery according to one embodiment is not limited to a prismatic battery, but may have any shape such as a cylinder, a coin, a pouch, and the like, as long as the rechargeable lithium battery include an electrolyte for a rechargeable lithium battery according to one embodiment.

The negative electrode includes a negative current collector and a negative active material layer disposed on the negative current collector.

The negative current collector may be a copper foil.

The negative active material layer may include a negative active material, a binder, and optionally a conductive material.

The negative active material may be the low crystalline carbon-based material described above.

The binder improves binding properties of the positive active material particles to each other and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material such as a metal powder or a metal fiber including copper, nickel, aluminum, silver, and the like; a conductive polymer such as a polyphenylene derivative; a mixture thereof.

The negative electrode may be fabricated by a method including mixing the negative active material, the conductive material, and the binder in a solvent to provide a negative active material layer composition, and coating the negative active material layer composition on the current collector. The solvent may be N-methylpyrrolidone, but it is not limited thereto.

A negative electrode including a low crystalline carbon-based material as a negative active material may have an active mass level ranging from 2.0 to 10.0 mg/cm² and in some embodiments, from 2.0 to 8.0 mg/cm². In addition, the negative electrode may have a thickness ranging from 45 to 100 μm and in some embodiments, from 45 to 80 μm. Furthermore, the negative electrode may have electrical conductivity ranging from 1.00 to 4.00 s/m and in some embodiments, from 1.50 to 3.50 s/m. In addition, the negative electrode may have binding properties ranging from 0.50 to 6.00 gf/mm and in some embodiments, from 2.00 to 6.00 gf/mm. A negative electrode with an active mass level, a thickness, electrical conductivity, and binding property within the range may realize a rechargeable lithium battery with excellent high rate capabilities and cycle-life characteristics at a high rate.

The positive electrode includes a current collector and a positive active material layer disposed on the current collector. The positive active material layer includes a positive active material, a binder, and optionally a conductive material.

The current collector may be aluminum (Al), but is not limited thereto.

The positive active material includes lithiated intercalation compounds that reversibly intercalate and deintercalate lithium ions. The positive active material may include a composite oxide including at least one selected from the group consisting of cobalt, manganese, and nickel, as well as lithium. In particular, the following lithium-containing compounds may be used:

LiₐA_{1-b}B_{b}D₂ (wherein, in the above formula, 0.90≦a≦1.8, and 0≦b≦0.5); LiₐE_{1-b}B_{b}O_{2-c}D_{c} (wherein, in the above formula, 0.90≦a≦1.8, 0≦b≦0.5, and 0≦c≦0.05); LiE_{2-b}B_{b}O_{4-c}D_{c} (wherein, in the above formula, 0≦b≦0.5, 0≦c≦0.05); LiₐNi_{1-b-c}Co_{b}B_{c}D_{α} (wherein, in the above formula, 0.90≦a≦1.8, 0≦b≦0.5, 0≦c≦0.05, and 0≦α≦2); LiₐNi_{1-b-c}Co_{b}B_{c}O_{2-α}X_{α} (wherein, in the above formula, 0.90≦a≦1.8, 0≦b≦0.5, 0≦c≦0.05, and 0<α<2); LiₐNi_{1-b-c}Co_{b}B_{c}O_{2-α}X₂(wherein, in the above formula, 0.90≦a≦1.8, 0≦b≦0.5, 0≦c≦0.05, and 0<α<2); LiₐNi_{1-b-c}Mn_{b}B_{c}D_{α} (wherein, in the above formula, 0.90≦a≦1.8, 0≦b≦0.5, 0≦c≦0.05, and 0<α≦2); LiₐNi_{1-b-c}Mn_{b}B_{c}O_{2-α}X_{α} (wherein, in the above formula, 0.90≦a≦1.8, 0≦b≦0.5, 0≦c≦0.05, and 0<α<2); LiₐNi_{1-b-c}Mn_{b}B_{c}O_{2-α}X₂ (wherein, in the above formula, 0.90≦a≦1.8, 0≦b≦0.5, 0≦c≦0.05, and 0<α<2); LiₐNi_{b}E_{c}G_{d}O₂ (wherein, in the above formula, 0.90≦a≦1.8, 0≦b≦0.9, 0≦c≦0.5, and 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d≦0.5, and 0.001≦e≦0.1); LiₐNiG_{b}O₂ (wherein, in the above formula, 0.90≦a≦1.8, and 0.001≦b≦0.1); LiₐCoG_{b}O₂ (wherein, in the above formula, 0.90≦a≦1.8, and 0.001≦b≦0.1); LiₐMnG_{b}O₂ (wherein, in the above formula, 0.90≦a≦1.8, and 0.001≦b≦0.1); LiₐMn₂G_{b}O₄ (wherein, in the above formula, 0.90≦a≦1.8, and 0.001≦b≦0.1); QO₂; QS₂; LiQS₂; V₂O₅; LiV₂O₅; LiRO₂; LiNiVO₄; Li_{(3-f)}J₂(PO₄)₃ (0≦f≦2); Li_{(3-f)}Fe₂(PO₄)₃ (0≦f≦2); and LiFePO₄.

In the formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; X is F, S, P, or a combination thereof; G is Al, Cr, Mn, Fe, Mg, La, Ce, Sr, V, or a combination thereof; Q is Ti, Mo, Mn, or a combination thereof; R is Cr, V, Fe, Sc, Y, or a combination thereof; J is V, Cr, Mn, Co, Ni, Cu, or a combination thereof.

The compound may have a coating layer on the surface, or can be mixed with a compound having a coating layer. The coating layer may include at least one coating element compound selected from the group consisting of an oxide of a coating element, a hydroxide, an oxyhydroxide of a coating element, an oxycarbonate of a coating element, and a hydroxyl carbonate of a coating element. The compounds for a coating layer can be amorphous or crystalline. The coating element for a coating layer may include Mg, Al, Co, K, Na, Ca, Si, Ti, V, Sn, Ge, Ga, B, As, Zr, or a mixture thereof. The coating layer can be formed in a method having no negative influence on properties of a positive active material by including these elements in the compound. For example, the method may include any coating method such as spray coating, dipping, and the like, but is not illustrated in more detail, since it is well-known to those who work in the related field.

The binder improves binding properties of the positive active material particles to each other and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Any electrically conductive material may be used as a conductive material unless it causes a chemical change. Examples of the conductive material include natural graphite, artificial graphite, carbon black, acetylene black, ketjen black, a carbon fiber, a metal powder or a metal fiber including copper, nickel, aluminum, silver, and so on, and a polyphenylene derivative.

The positive electrode may be fabricated by a method including mixing the active material, a conductive material, and a binder to provide an active material composition, and coating the composition on a current collector.

The electrode manufacturing method is well known, and thus is not described in detail in the present specification. The solvent may be N-methylpyrrolidone, but it is not limited thereto.

The electrolyte includes a non-aqueous organic solvent and a lithium salt.

The non-aqueous organic solvent serves as a medium for transmitting ions taking part in the electrochemical reaction of a battery. The non-aqueous organic solvent may include a carbonate-based, ester-based, ether-based, ketone-based, alcohol-based, or aprotic solvent.

Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like.

When the linear carbonate compounds and cyclic carbonate compounds are mixed, an organic solvent having high dielectric constant and low viscosity can be provided. The cyclic carbonate and the linear carbonate are mixed together at a volume ratio ranging from about 1:1 to about 1:9.

Examples of the ester-based solvent may include n-methylacetate, n-ethylacetate, n-propylacetate, dimethylacetate, methylpropinonate, ethylpropinonate, γ-butyrolactone, decanolide, valerolactone, mevalonolactone, caprolactone, or the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone, or the like. Examples of the alcohol-based solvent include ethyl alcohol, isopropyl alcohol, or the like.

The non-aqueous organic solvent may be used singularly or in a mixture. When the organic solvent is used in a mixture, the mixture ratio can be controlled in accordance with a desirable battery performance.

The non-aqueous electrolyte may further include overcharge inhibitor additives such as ethylene carbonate, pyrocarbonate, or the like.

The lithium salt supplies lithium ions in the battery, operates a basic operation of a rechargeable lithium battery, and improves lithium ion transportation between positive and negative electrodes.

Examples of the lithium salt include LiPF₆, LiBF₄, LiSbF₆, LiAsF₆, LiN (SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂ (lithium bisoxalato borate, LiBOB), or a combination thereof.

The lithium salt may be used in a concentration ranging from about 0.1 M to about 2.0 M. When the lithium salt is included at the above concentration range, electrolyte performance and lithium ion mobility may be enhanced due to optimal ion conductivity and viscosity.

The separator may be a single layer or multilayer, and may, for example comprise polyethylene, polypropylene, polyvinylidene fluoride, or combinations thereof.

The rechargeable lithium battery including the low crystalline carbon-based material as a negative active material, it may improve reversible capacity may have improved reversible capacity. In particular, the rechargeable lithium battery may have reversible capacity ranging from 250 to 400 mAh/g and in some embodiments, 250 to 350 mAh/g. The reversible capacity is measured under a condition of 0.2 C.

Hereinafter, the embodiments are illustrated in more detail with reference to examples. However, the following are example embodiments and are not limiting.

A person having ordinary skills in this art can sufficiently understand parts of the present embodiments that are not specifically described.

### Preparation of Negative Active Material

### EXAMPLE 1

Low crystalline soft carbon (GS Caltex Co.) with an average particle diameter (D50) of 9.8 μm was used as a negative active material. Herein, the low crystalline soft carbon was obtained by firing soft carbon at 950° C.

### COMPARATIVE EXAMPLE 1

Graphite with an average particle diameter (D50) of 10 μm was used as a negative active material.

### COMPARATIVE EXAMPLE 2

Soft carbon (Hitachi Ltd.) with an average particle diameter (D50) of 10 μm was used as a negative active material.

### Evaluation 1: SEM Photograph Analysis of Negative Active Material

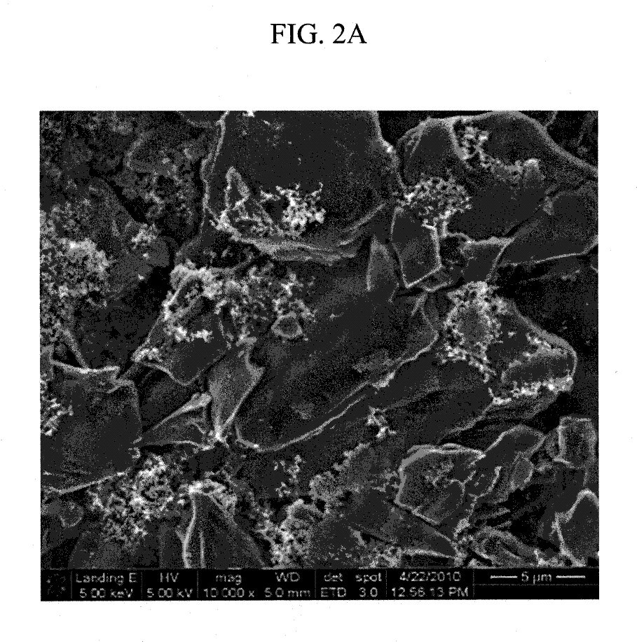

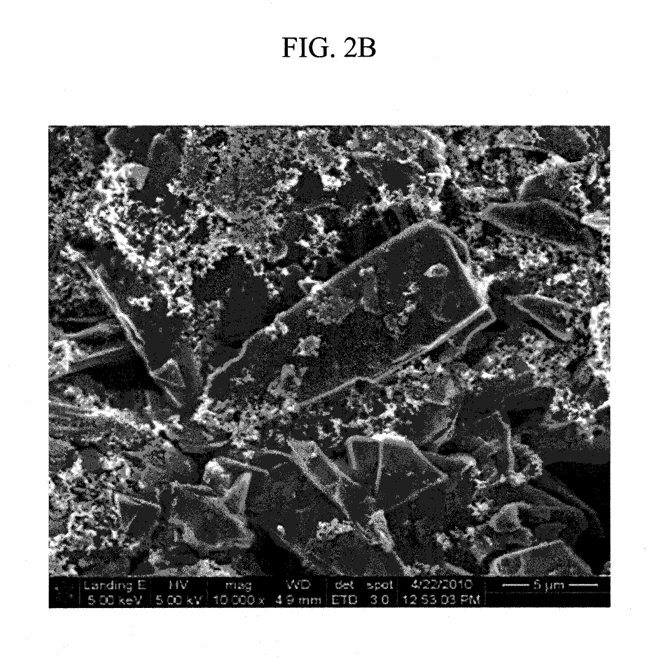

FIGS. 2a and 2b provide SEM (scanning electron microscope) photographs of the negative active materials according to Example 1 and Comparative Example 2.

Referring to FIGS. 2a and 2b, the negative active material of Example 1 had lower crystalline than the negative active material of Comparative Example 2.

Evaluation 2: XRD pattern analysis of Negative active material

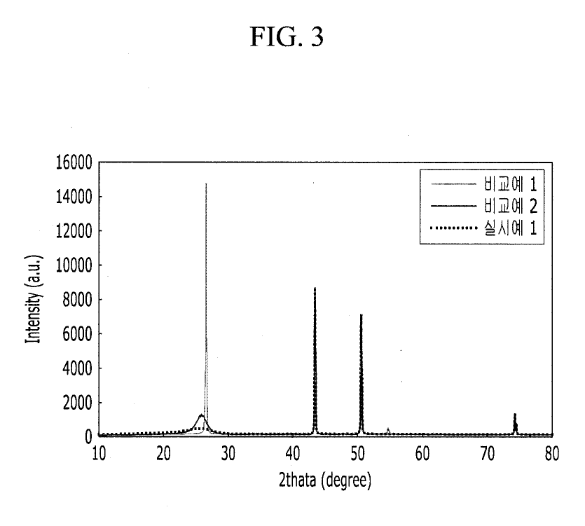

FIG. 3 provides a graph showing XRD (X-ray diffraction) pattern of the negative active materials according to Example 1 and Comparative Example 1 and 2. In addition, Table 1 shows the area of a peak in the XRD pattern shown in FIG. 3.

The XRD pattern was measured with 40 Kv of tube voltage and 30 mA of tube current at a step of 0.02° in a range of 10° to 90° at a speed of 0.5 sec/step by using CuKα ray.

TABLE 1

| | | Comparative | Comparative |
|---|---|---|---|
| 2θ(degree) | Example 1 | Example 1 | Example 2 |
| 20° to 30° | 1,069,762 | 12,505 | 5,596,428 |
| 42° to 45° | 3,594,512 | 2,928,339 | 3,463,052 |
| 50° to 53° | 4,064,299 | 3,320,066 | 3,964,013 |

Referring to FIG. 3, Example 1 including a low crystalline carbon-based material according to one embodiment had FWHM of about 4.18° at 20 in a range of 20° to 30° while Comparative Example 1 had FWHM of about 0.34°, and Comparative Example 2 had FWHM of about 1.82°.

In addition, referring to FIG. 3 and the Table 1, Example 1 had about 3.8 of a peak area ratio of 2θ in a range of 50° to 53° relative to 2θ in a range of 20° to 30°, while Comparative Example 1 had about 265.5, and Comparative Example 2 had about 0.71.

Accordingly, the carbon-based material used in Example 1 was low crystalline.

### Evaluation 3: EDS (Energy Dispersive Spectrometry) Analysis of Negative Active Material

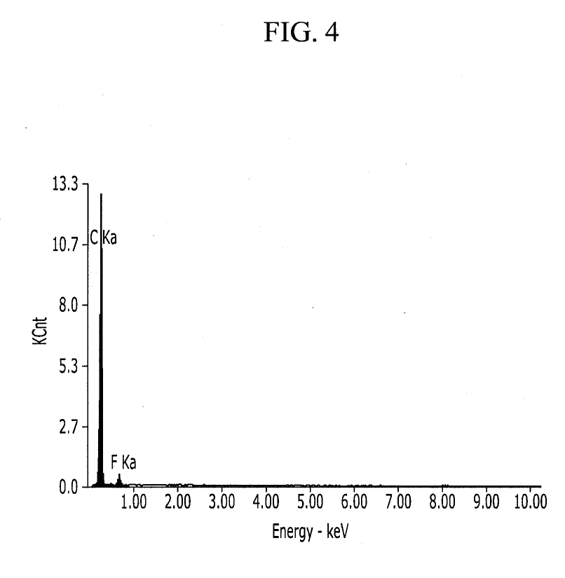

FIG. 4 provides the EDS (Energy Dispersive Spectrometry) analysis graph of the negative active material according to Example 1.

Referring to FIG. 4, the negative active material of Example 1 included no other material other than carbon.

### Evaluation 4: Crystal Structure Analysis of Negative Active Material

The negative active materials according to Example 1 and Comparative Examples 1 and 2 were analyzed regarding crystal structure in the following method. The results are provided in the following Table 2.

In the XRD pattern, a basal spacing (d), a distance from 2θ of the peaks to a lattice, was obtained in a Bragg's law. Accordingly, all the peaks in the XRD pattern were analyzed regarding location to identify distribution on the lattice in the crystal structure.

TABLE 2

| | | Comparative | Comparative |
|---|---|---|---|
| | Example 1 | Example 1 | Example 2 |
| Interplanar spacing d(002) of | 3.43 | 3.34 | 3.44 |
| carbon (Å) | | | |
| Lattice constant Lₐ (Å) | 1809 | 1783 | 1904 |
| Lattice constant L_{c} (Å) | 26 | 616 | 48 |

Referring to Table 2, a carbon-based material used as a negative active material according to one embodiment was identified to be low crystalline.

### Evaluation 5: Specific Surface Area Analysis of Negative Active Material

The negative active materials according to Example 1 and Comparative Examples 1 and 2 were measured regarding specific surface area by using a dispersion analyzer (Lumisizer). As a result, the negative active material of Example 1 had a specific surface area of 3 m²/g, Comparative Example 1 a specific surface area of 2 m²/g, and Comparative Example 2 had a specific surface area of 2 m²/g.

### Evaluation 6: Tap Density and True Density Analysis of Negative Active Material

The negative active materials according to Example 1 and Comparative Examples 1 and 2 were analyzed regarding tap density by using tap density analyzer (TDA-2). As a result, the negative active material of Example 1 had 0.939 g/cm³, Comparative Example 1 had 1.08 g/cm³, and Comparative Example 2 had 1.09 g/cm³.

In addition, the negative active materials according to Example 1 and Comparative Examples 1 and 2 were measured regarding true density by using a sequential auto powder true density meter. As a result, the negative active material of Example 1 had 1.941 g/cm³, Comparative Example 1 had 3.05 g/cm³, and Comparative Example 2 had 3.08 g/cm³.

Accordingly, a negative active material according to one embodiment was identified to be a low crystalline carbon-based material.

### Fabrication of Rechargeable Lithium Battery Cell

85 wt % of the low crystalline soft carbons according to Example 1 and Comparatives Example 1 and 2 were respectively mixed with 10 wt % of polyvinylidene fluoride (PVDF) and 5 wt % of acetylene black. The mixture was dispersed into N-methyl-2-pyrrolidone, preparing a negative active material layer composition. Next, the negative active material layer composition was coated on a copper foil and then, dried and compressed, fabricating a negative electrode. Herein, the negative electrode of Example 1 had a thickness of 60 μm, the negative electrode of Comparative Example 1 had a thickness of 53 μm, and the negative electrode of Comparative Example 2 had a thickness of 65 μm.

85 wt % of LiCoO₂ with an average particle diameter of 5 um was mixed with 6 wt % of polyvinylidene fluoride (PVDF), 4 wt % of acetylene black, and 5 wt % of activated carbon. The mixture was dispersed into N-methyl-2-pyrrolidon, preparing a positive active material layer composition. The positive active material layer composition was coated on a 20 μm-thick aluminum foil and then, dried and compressed, fabricating a positive electrode.

The positive and negative electrodes and a 25 μm-thick polyethylene material separator were wound and compressed, fabricating a 50 mAh pouch-type rechargeable lithium battery cell.

Herein, an electrolyte solution was prepared by mixing ethylenecarbonate (EC), ethylmethylcarbonate (EMC) and dimethylcarbonate (DMC) in a volume ratio of 3:3:4 and dissolving LiPF₆ in the mixed solution to be all 5M concentration.

### Evaluation 7: Active Mass Level Evaluation of Negative Electrode

Each negative electrode fabricated respectively using the negative active materials according to Example 1 and Comparative Examples 1 and 2 were measured regarding weight per area with an electric scale to analyze active mass level. As a result, the negative electrode of Example 1 had 5.05 mg/cm², while the negative electrode of Comparative Example 1 had 5.12 mg/cm² and the negative electrode of Comparative Example 2 had 5.52 mg/cm².

### Evaluation 8: Electrical Conductivity Evaluation of Negative Electrode

Each negative electrode fabricated by respectively using the negative active material according to Example 1 and Comparative Examples 1 and 2 were analyzed regarding electrical conductivity. As a result, the negative electrode of Example 1 had 2.504 s/m, the negative electrode of Comparative Example 1 had 0.683 s/m, and the negative electrode of Comparative Example 2 had 2.093 s/m.

Accordingly, a negative electrode according to one embodiment included a low crystalline carbon-based material and thus, had high electrical conductivity, accomplishing excellent cycle-life at a high rate.

### Evaluation 9: Binding Property Evaluation of Negative Electrode

Each negative electrode fabricated by respectively using the negative active material according to Example 1 and Comparative Examples 1 and 2 were analyzed regarding binding properties. As a result, the negative electrode of Example 1 had 4.05 gf/mm, the negative electrode of Comparative Example 1 had 3.24 gf/mm, and the negative electrode Comparative Example 2 had 3.24 gf/mm.

Accordingly, a negative electrode according to one embodiment included a low crystalline carbon-based material and had high binding property, accomplishing excellent cycle-life at a high rate.

### Evaluation 10: Irreversible Capacity Evaluation of Rechargeable Lithium Battery Cell

Each rechargeable lithium battery cell fabricated respectively using the negative active material Example 1 and Comparative Examples 1 and 2 were charged and discharged under the following condition described in the Table 3. Table 4 provides capacity of the rechargeable lithium battery cells.

TABLE 3

| | | C rate | cut-off | | Open time |
|---|---|---|---|---|---|
| | | (C) | voltage(V) | mode | (min) |
| 1 cycle | charge | 0.05 | 3.0 | CC | 20 |
| 2 cycle | charge | 0.2 | 4.0 | CC | 20 |
| | discharge | 0.2 | 2.0 | CC | 20 |
| 3 cycle | charge | 0.2 | 4.1 | CC | 20 |
| | discharge | 0.2 | 2.0 | CC | 20 |
| 4 cycle | charge | 0.2 | 4.2 | CC | 20 |
| | discharge | 0.2 | 2.0 | CC | 20 |
| 5 cycle | charge | 0.2 | 4.2 (0.05 C) | CCCV | 20 |
| | discharge | 0.2 | 2.0 | CC | 20 |
| 6 to 10 cycles | charge | 1.0 | 4.2 (0.05 C) | CCCV | 20 |
| | discharge | 1.0 | 2.0 | CC | 20 |

TABLE 4

| | | Comparative | Comparative |
|---|---|---|---|
| | Example 1 | Example 1 | Example 2 |
| Irreversible capacity of 10 | 18.50 | 3.11 | 18.84 |
| cycle(mAh/g) | | | |
| discharge capacity of 5 cycle | 68.27 | 58.67 | 49.28 |
| (mAh/g) | | | |
| Irreversible capacity retention | 21.32 | 5.03 | 27.65 |
| (%)* | | | |

*Irreversible capacity retention (%) = Irreversible capacity of 10 cycle/(Irreversible capacity of 10 cycle + discharge capacity of 5 cycle) * 100

Referring to Table 4, Example 1 including a low crystalline carbon-based material as a negative active material according to one embodiment has a better effect in terms of Irreversible capacity, compared to Comparative Example 2.

### Evaluation 11: Cycle-Life at a High Rate Evaluation of Rechargeable Lithium Battery Cell

Each rechargeable lithium battery cell respectively including the negative active materials according to Example 1 and Comparative Examples 1 and 2 were charged and discharged under the following condition and evaluated regarding cycle-life at a high rate. The results are provided in the following Table 5.

The rechargeable lithium battery cells were charged up to 4.2V under CC mode and charged up to 0.05 C under CV mode and discharged down to 2.0V under CC mode and then, cut-off.

The following charge capacity retention (%) and discharge capacity retention (%) are a percentage of capacity at 50 C relative to capacity at 1 C.

TABLE 5

| | | | Comparative | Comparative |
|---|---|---|---|---|
| | | Example 1 | Example 1 | Example 2 |
| charge capacity | 1 C | 213 | 264 | 189 |
| (mAh/g) | 50 C | 129 | 31 | 104 |
| charge capacity retention | | 61 | 11.7 | 55 |
| (50 C/1 C) (%) | | | | |
| Discharge capacity | 1 C | 217 | 270 | 192 |
| (mAh/g) | 50 C | 173 | 212 | 160 |

| | | | |
|---|---|---|---|
| Discharge capacity retention | 83 | 78.5 | 79.7 |
| (50 C/1 C) (%) | | | |

Referring to Table 5, Example 1 including a low crystalline carbon-based material as a negative active material according to one embodiment had excellent high rate charge characteristics compared with Comparative Examples 1 and 2.

### Evaluation 12: Cycle-Life at a High Rate Evaluation of Rechargeable Lithium Battery Cell

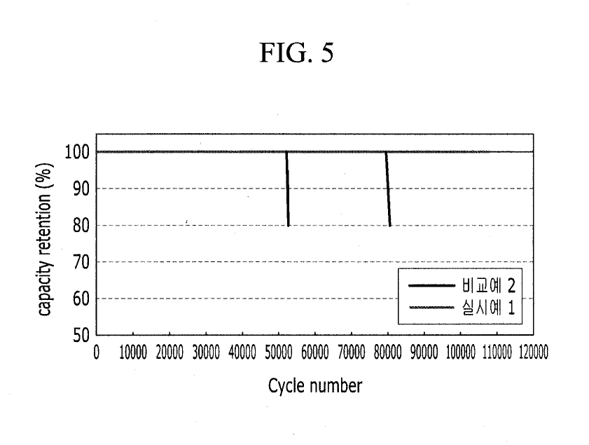

Each rechargeable lithium battery cell respectively including the negative active material according to Example 1 and Comparative Examples 1 and 2 were charged and discharged under the following condition and measured regarding cycle-life at a high rate. The results are provided in FIG. 5.

30 C charge mode: charged for 30 sec at 30 C of a charge current

30 C discharge mode: discharged for 30 sec at 30 C of a discharge current

FIG. 5 provides a graph showing cycle-life of rechargeable lithium battery cells of Example 1 and Comparative Example 2 at a high rate.

Referring to FIG. 5, the rechargeable lithium battery cell of Example 1 had no cycle-life degradation after 120000 cycles, while the rechargeable lithium battery cell of Comparative Example 2 had cycle-life degradation after 50000 cycles.

While this disclosure has been described in connection with what is presently considered to be practical example embodiments, it is to be understood that the present embodiments are not limited to the disclosed embodiments, but, on the contrary, is intended to cover various modifications and equivalent arrangements included within the spirit and scope of the appended claims.

What is claimed is:

1. A negative active material for a secondary lithium battery comprising a carbon-based material,
wherein the carbon-based material has a full width at half maximum (FWHM) ranging from 2.5° to 6.0° at 2θ ranging from 20° to 30° in a XRD pattern using CuKα radiation and a peak area ratio ranging from 1.0 to 100.0 of a peak at 2θ ranging from 50° to 53° relative to a peak at 2θ ranging from 20° to 30°.

2. The negative active material of claim 1, wherein the carbon-based material has an R_{AB} value of from about 2.0 to about 4.0, wherein (R_{AB}) is the ratio of the height of a peak (B) to the height of the background (A) in an XRD pattern.

3. The negative active material of claim 1, wherein the carbon-based material comprises carbon with an interplanar spacing d(002) of from 3.370 to 3.434 Å.

4. The negative active material of claim 1, wherein the carbon-based material has a FWHM ranging from 3.5° to 5.5° at 2θ ranging from 20° to 30° in a XRD pattern using CuKα radiation.

5. The negative active material of claim 1, wherein the carbon-based material has a peak area ratio ranging from 1.0 to 100.0 of a peak at 2θ ranging from 42° to 45° relative to the peak at 2θ ranging from 20° to 30° in the XRD pattern using CuKα radiation.

6. The negative active material of claim 1, wherein the carbon-based material has a peak area ratio ranging from 0.1 to 50.0 of the peak at 2θ ranging from 50° to 53° relative to a peak at 2θ ranging from 42° to 45° in the XRD pattern using CuKα ray.

7. The negative active material of claim 1, wherein the carbon-based material has a specific surface area ranging from 2.5 to 20 m²/g.

8. The negative active material of claim 1, wherein the carbon in the carbon-based material has a lattice constant of L_{c} ranging from 10 to 35 Å.

9. The negative active material of claim 1, wherein the carbon-based material has tap density ranging from 0.30 to 1.00 g/cm³.

10. The negative active material of claim 1, wherein the carbon-based material has a true density ranging from 1.00 to 3.00 g/cm³.

11. A method of manufacturing the negative active material for a secondary lithium battery of claim 1 comprising:
providing the carbon-based material; and
firing the carbon-based material at a temperature of from about 900° C. to about 1500° C.

12. A secondary lithium battery comprising:
a positive electrode,
a negative electrode,
a separator;
and an electrolyte,
wherein the negative electrode comprises negative active material comprising a carbon-based material,
wherein the carbon-based material has a full width at half maximum (FWHM) ranging from 2.5° to 6.0° at 2θ ranging from 20° to 30° in a XRD pattern using CuKα radiation and a peak area ratio ranging from 1.0 to 100.0 of a peak at 2θ ranging from 50° to 53° relative to a peak at 2θ ranging from 20° to 30°.

13. The secondary lithium battery of claim 12, wherein the carbon-based material has an R_{AB} value of from about 2.0 to about 4.0, wherein (R_{AB}) is the ratio of the height of a peak (B) to the height of the background (A) in an XRD pattern.

14. The secondary lithium battery of claim 12, wherein the carbon-based material comprises carbon with an interplanar spacing d(002) of from 3.370 to 3.434 Å.

15. The secondary lithium battery of claim 12, wherein the carbon-based material has a FWHM ranging from 3.5° to 5.5° at 2θ ranging from 20° to 30° in a XRD pattern using CuKα radiation.

16. The secondary lithium battery of claim 12, wherein the carbon-based material has a peak area ratio ranging from 1.0 to 100.0 of a peak at 2θ ranging from 42° to 45° relative to the peak at 2θ ranging from 20° to 30° in the XRD pattern using CuKα radiation.

17. The secondary lithium battery of claim 12, wherein the carbon-based material has a peak area ratio ranging from 0.1 to 50.0 of a the peak at 2θ ranging from 50° to 53° relative to a peak at 2θ ranging from 42° to 45° in the XRD pattern using CuKα ray.

18. The secondary lithium battery of claim 12, wherein the carbon in the carbon-based material has a lattice constant of L_{c} ranging from 10 to 35 Å.

19. The secondary lithium battery of claim 12, wherein the carbon-based material has a specific surface area ranging from 2.5 to 20 m²/g.

20. The secondary lithium battery of claim 12, wherein the carbon-based material has tap density ranging from 0.30 to 1.00 g/cm³ .

21. The secondary lithium battery of claim 12, wherein the carbon-based material has a true density ranging from 1.00 to 3.00 g/cm³.
